(19) United States
(12) Patent Application Publication
(10) Pub. No.: US 2024/0402374 A1
(43) Pub. Date: Dec. 5, 2024

(54) SENSOR ASSEMBLY

(71) Applicant: Lear Corporation, Southfield, MI (US)

(72) Inventors: Ajmal Ansari, Canton, MI (US); Greg Dickerhoof, Ann Arbor, MI (US); Michael Scott Duco, Fraser, MI (US)

(21) Appl. No.: 18/203,778

(22) Filed: May 31, 2023

(51) Int. Cl. G01V 3/02; H01R 4/24

(52) U.S. Cl. CPC G01V 3/02; H01R 4/24

(57) ABSTRACT

A sensor assembly includes an electrical connector, a cable connected to the electrical connector, and a bracket. The electrical connector may include a pair of electrodes electrically connected to the cable. The electrical connector may be supported by the bracket such that the electrical connector is positioned about a bottom portion of the bracket. The pair of electrodes may be separated from each other and extend down from the electrical connector a length into a space provided below the electrical connector.

### TECHNICAL FIELD

The present disclosure generally relates to a sensor assembly, including sensor assemblies that may be connected to a battery, and/or may be used in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and are not restricted to the precise form and configuration shown in the drawings or disclosed in the following detailed description. Exemplary illustrations are described in detail by referring to the drawings as follows:

FIG. 1 is a perspective view generally illustrating an embodiment of a sensor assembly implemented in an exemplary housing according to teachings of the present disclosure.

FIG. 2 is a perspective view generally illustrating an embodiment of a sensor assembly attached to a circuit board according to teachings of the present disclosure.

FIG. 3 is a perspective view generally illustrating portions of an embodiment of a sensor assembly attached to a circuit board according to teachings of the present disclosure.

FIG. 4 is a perspective view generally illustrating an embodiment of a sensor assembly according to teachings of the present disclosure

FIG. 5A is a front view generally illustrating an embodiment of a sensor assembly in normal conditions according to teachings of the present disclosure.

FIG. 5B is a front view generally illustrating an embodiment of a sensor assembly in the presence of a conductive fluid according to teachings of the present disclosure.

FIG. 6 is a top view generally illustrating an embodiment of a first sensor in a chain of sensors in the sensor assembly according to teachings of the present disclosure.

FIG. 7 is a side view generally illustrating an embodiment of a sensor housing according to teachings of the present disclosure.

FIG. 8 is a perspective view generally illustrating an embodiment of an intermediate or a last sensor in a chain of sensors of the sensor assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

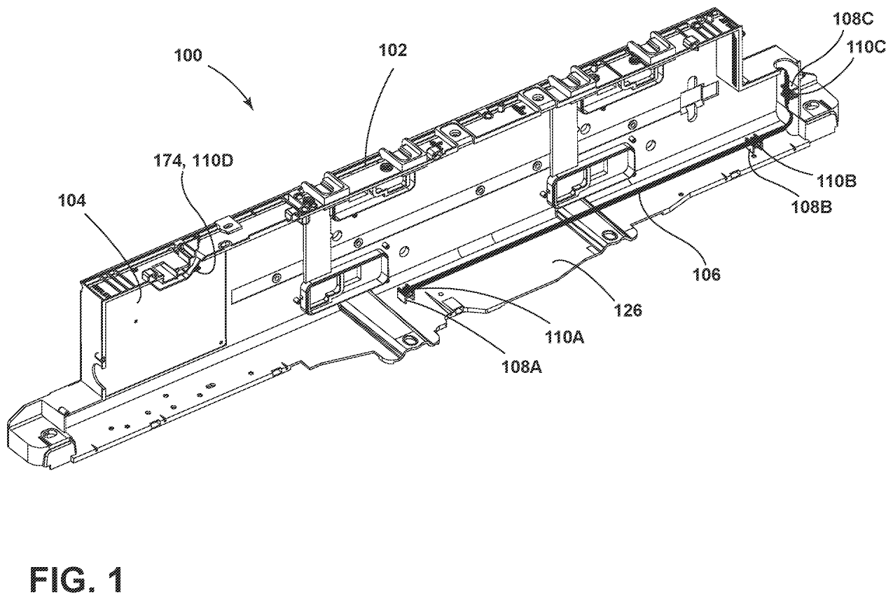

Referring to FIG. 1, an embodiment of a sensor assembly 100 is depicted in an exemplary housing 102. The sensor assembly 100 is configured for use with a vehicle. However, the sensor assembly 100 can be utilized in other situations, with other apparatuses, and/or for other applications. The sensor assembly 100 detects a presence of electrically conductive fluid and provides a signal or information to a circuit board (e.g., a battery disconnect sensing board), which can implement or initiate appropriate action to prevent a thermal event by, for example, opening a contactor or a switch. However, the signal or information can also be provided to other boards and/or devices such as a pyro fuse, which may involve other applications.

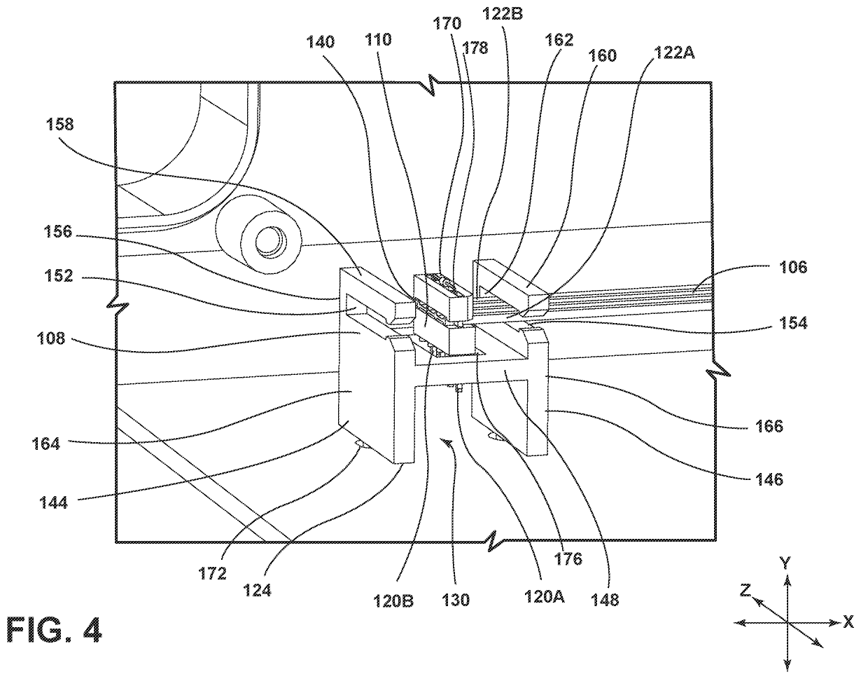

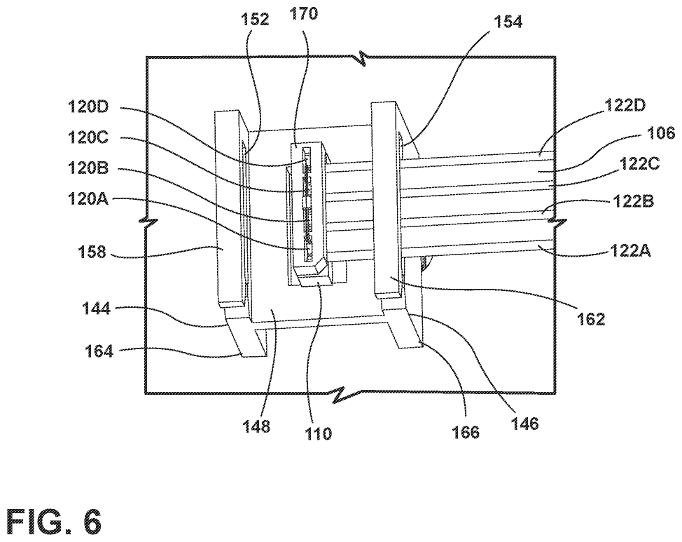

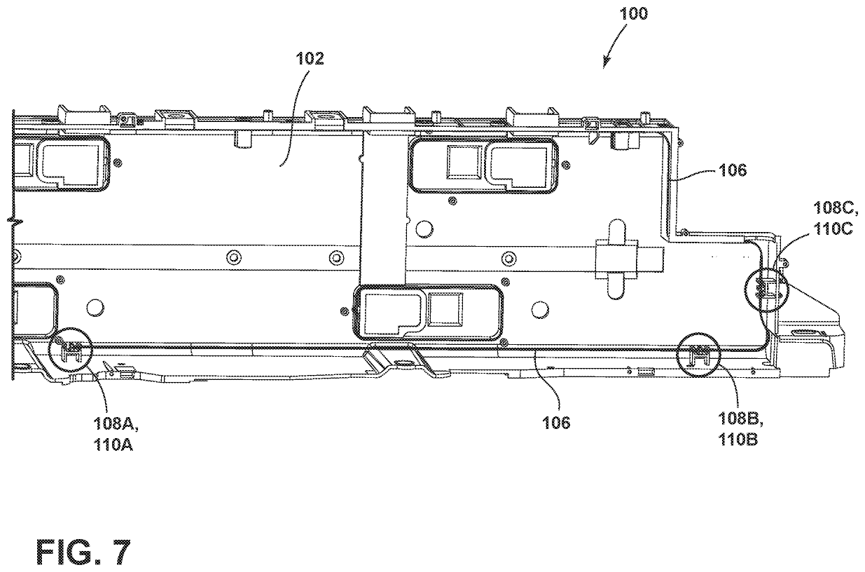

Referring to FIGS. 1 and 4, the sensor assembly 100 is at least partially disposed in the housing 102 (e.g., an enclosure), and includes a circuit board 104, a cable 106, a bracket 108, and an electrical connector 110. In some configurations, the sensor assembly 100 includes a plurality of brackets 108 and a plurality of electrical connectors (see, e.g., FIGS. 1 and 7). In some configurations, the electrical connector 110 is an insulation displacement connector, but other electrical connectors may be used in other applications. In some configurations, the cable 106 is planar cable—for example, and without limitation, a planar cable may comprise a ribbon cable, flat flex cable, or another type of planar cable. In configurations, cable 106 may comprise an insulated, flat ribbon cable, but other types or forms of cables (e.g., planar cables) may be used in other applications, for example, flat flex cables. The electrical connector 110 includes a pair of electrodes 120A, 120B (e.g., a first electrode 120A and a second electrodes 120B) and is electrically connected to the cable 106 via the pair of electrodes 120A, 120B. For example, the pair of electrodes 120A, 120B are pressed or otherwise extend through a pair of conductors 122A, 122B (e.g., a first conductor 122A and a second conductor 122B) in the cable 106 (see, e.g., FIG. 6). The electrical connector 110 is supported by the bracket 108 such that the electrical connector 110 is positioned above a bottom portion 124 of the bracket 108. For example, the bracket 108 is connected to an inner surface 126 of the housing 102, and the electrical connector 110 is positioned above the bottom portion 124 of the bracket 108 such that the electrical connector 110 is positioned above the inner surface 126 of the housing 102. The pair of electrodes 120A, 120B are separated from each other such that under normal conditions, each electrode of the pair of electrodes 120A, 120B are spaced or isolated from the other electrode of the pair of electrodes 120A, 120B. The pair of electrodes 120A, 120B extend down from the electrical connector 110 a length L into a space 130 provided below the electrical connector 110 (e.g., in the space 130 between the end of the pair of electrodes 120A, 120B and the inner surface 126 of the housing 102.

The housing 102 extends generally in a first direction (e.g., a generally X-direction). The electrical connector 110, the bracket 106, and at least a portion of the cable 106 are disposed in the housing 102. The cable 106 may extend generally parallel (e.g., generally in the X-direction) along at or about a bottom inner surface of the housing 102 for at least a portion of the cable 106. The circuit board 104 may be positioned adjacent to a top inner surface of the housing 102 such that the circuit board is generally above (e.g., in a generally Y-direction) at least a portion of the cable 106. The housing 102 may include more than one electrical connector 110 and bracket 108 along the length of the cable 106 (e.g., see FIGS. 1 and 7). The cable 106 may begin at an electrical connector 110, extend along the periphery of the housing 102, and terminate at the circuit board 104.

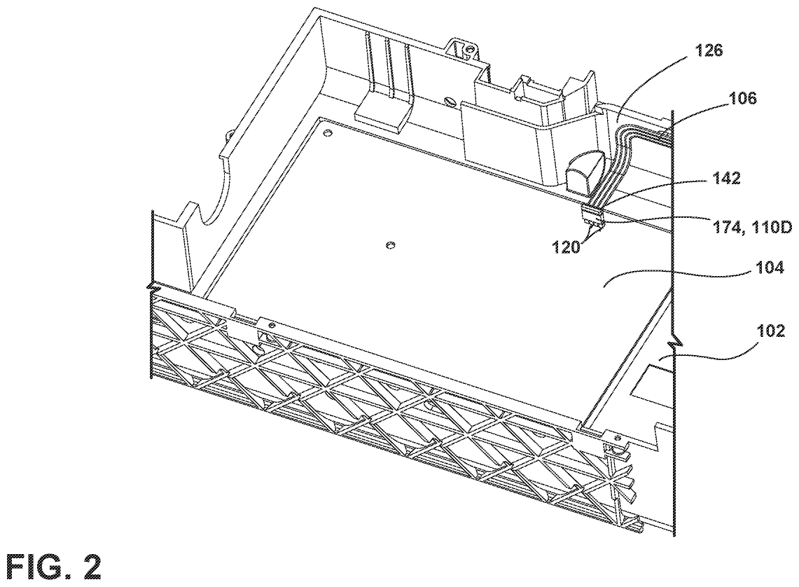

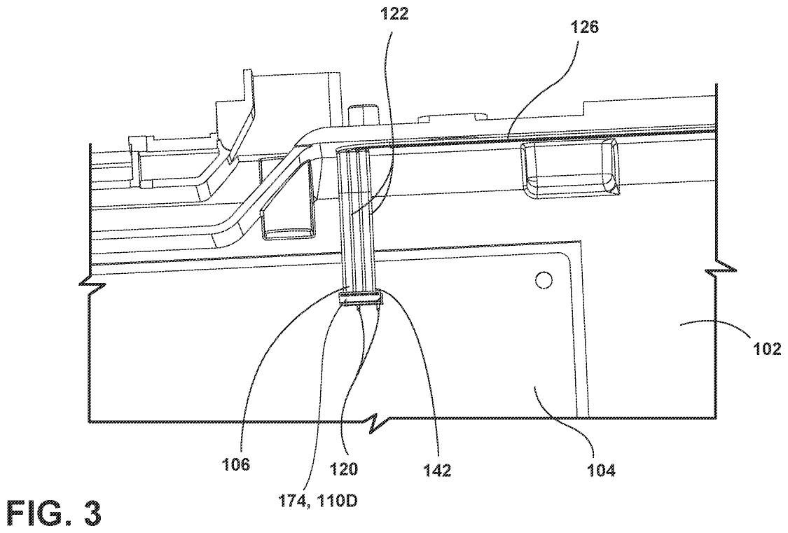

Referring to FIGS. 2 and 3, the cable 106 is operatively connected to the circuit board 104. In some configurations, the circuit board 104 may be a battery disconnect sensing board and/or a battery disconnect unit that routes electrical power in and out of a battery. For example, in the presence of a conductive fluid, information (e.g., an electrical signal) is sent to the circuit board 104 via the cable 106 that the conductive fluid is present and to take appropriate safety action (e.g., effectuate reduction and/or termination of power distribution from the battery or charge station to the vehicle and/or electrically isolate the battery from the rest of the vehicle and charge station) to reduce or eliminate effects of short circuit current flow from the conductive fluid contacting the battery or other electronic components.

The cable 106 extends along at or about at least a portion of the inner surface 126 of the housing 102 and connects to and/or terminates at the circuit board 104 (see, e.g., FIGS. 1-3). The cable 106 includes a first end 140 which may begin at a first electrical connector 110 that is configured to operate as a sensor (see, e.g., FIG. 4). The cable includes a second end 142, opposite the first end 140, that is operatively connected to the circuit board 104 (see, e.g., FIGS. 2 and 3). An electrical connector 110 is positioned at the second end 142 of the cable 106. The pair of electrodes 120 from the electrical connector 110 are electrically connected to the circuit board 104 via a mating connector 174 (e.g., a mating header connector) which may be soldered to the circuit board 104. Signals may travel from the first end 140 of the cable 106 at the first electrical connector 110A (see, e.g., FIG. 7) and be received at the circuit board 104 via the connection of the pair of electrodes 120 from the electrical connector 110D (see, e.g., FIG. 7) connected to the circuit board 104.

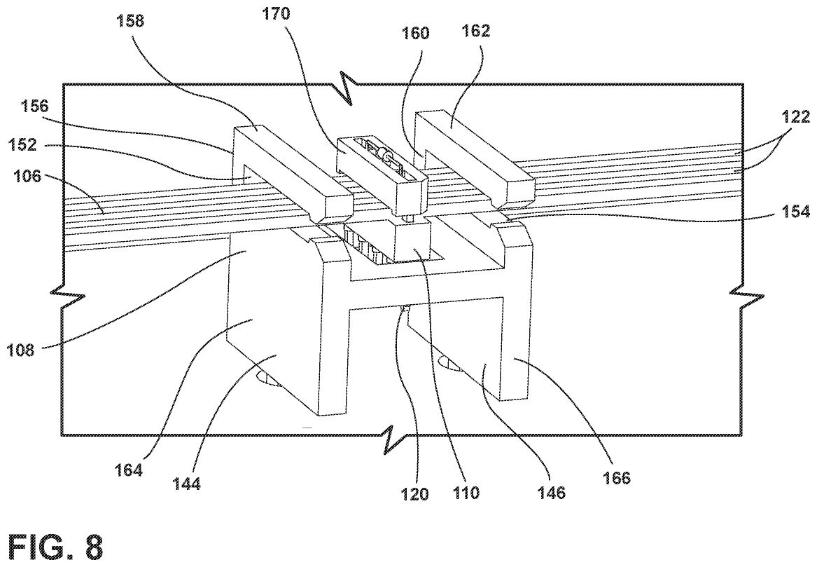

Referring to FIGS. 4 and 8, the electrical connector 110 is supported by the bracket 108 and attached to the cable 106. The bracket 108 includes a first leg 144 and a second leg 146. Each of the first leg 144 and the second leg 146 are connected to the inner surface 126 of the housing 102 at the lower extent 124 of the bracket 108 and extend in a direction generally perpendicular (e.g., generally in the Y-direction) from the inner surface 126. The first leg 144 and the second leg 146 may be connected to the inner surface 126 via an attachment member 172 (e.g., a barbed post, screws). A crossbeam 148 extends from the first leg 144 to the second leg 146 in a direction generally parallel (e.g., generally in the X-direction) to the inner surface 126. The electrical connector 110 is supported by the bracket 108 at least in part via the crossbeam 148. Crossbeam 148 includes a connector location 176 for positioning and locating the connector 110 in the bracket 108. Connector location 176 may include an opening with or without ridges for retaining the connector 110 in the crossbeam 148 of the bracket 108. Connector location 176 may additionally include further latches or securing means to provide further stability to connector 110. The pair of electrodes 120A, 120B extend from the electrical connector 110 in a downward direction generally into the space 130 between the first leg 144, the second leg 146, the crossbeam 148, and the inner surface 126 of the housing 102.

The bracket 110 includes a first slot 152 in the first leg 144 and a second slot 154 in the second leg 144. The first slot 152 is provided by a first bottom portion 164 of the first leg 144, a first back wall 156 which extends vertically (e.g., generally in the Y-direction) from the first bottom portion 164, and a first top portion 158 of the first leg 144 which extends generally in the Z-direction from the first back wall 156. The first bottom portion 164, the first back wall 156, and the first top portion 158 may be generally c-shaped, creating the first slot 152. The second slot 154 is provided by a second bottom portion 166 of the second leg 146, a second back wall 160 that extends vertically (e.g., generally in the Y-direction) from the second bottom portion 166, and a second top portion 162 of the second leg 146 that extends generally in the Z-direction from the second back wall 160. The second bottom portion 166, the second back wall 160, and the second top portion 162 may be generally c-shaped, creating the second slot 156. The cable 106 may extend through at least one of the first slot 152 and the second slot 154 such that the cable 106 passes through the bracket 108 via the slots 152, 154. In some configurations, the bracket 106 may be positioned at the first end 140 of the cable 106 such that the cable 106 begins at the electrical connector 110 and extends through the second slot 154 (see, e.g., FIG. 4). In some configurations, the bracket 106 may be positioned along the length of the cable 106 at neither of the first end 140 or the second end 142 of the cable 106 such that the cable 106 travels through both of the first slot 152 and the second slot 154 (see, e.g., FIG. 8).

Referring to FIGS. 4, 6, and 8, the electrical connector 110 may include a latch 170 to secure the cable 106 to the electrical connector 110. For example, the electrical connector 110 includes the pair of electrodes 120A, 120B which also extend in a direction upward from the electrical connector 110 (e.g., generally in the Y-direction). The pair of electrodes 120A, 120B pass through the pair of conductor wires 122A, 122B in the cable 106 to operatively connect the electrodes 120A, 120B with the conductors 122A, 122B (e.g., a first electrode 120A of the pair of electrodes 120 passes through a first conductor wire 122A of the pair of conductor wires 122, and a second electrode 120B of the pair of electrodes 120 passes through a second conductor wire 122B of the pair of conductor wires 122). The latch 170 may be adapted to secure the cable 106 to the electrical connector 110 via clamping to a top surface of the electrical connector 110 over the cable 106.

Referring to FIG. 6, the bracket 106 and electrical connector 110 are illustrated from a top view. In some configurations, more than one pair of electrodes 120 and conductors 122 may be included. The illustrated electrical connector 110 includes four electrodes 120 and the cable 106 includes four conductors 122. At least two electrodes 120 and two conductors 122 are required, but a sensor assembly 100 may include more. In the illustrated embodiment, a first electrode 120A is connected to a first conductor 122A, a second electrode 120B is connected to a second conductor 122B, a third electrode 120C is connected to a third conductor 122C, and a fourth electrode 120D is connected to a fourth conductor 122D. The latch 170 is positioned over the cable 106 at the electrical connector 110 to clamp the cable 106 to the electrical connector 110 and to secure the electrodes 120 to the conductors 122.

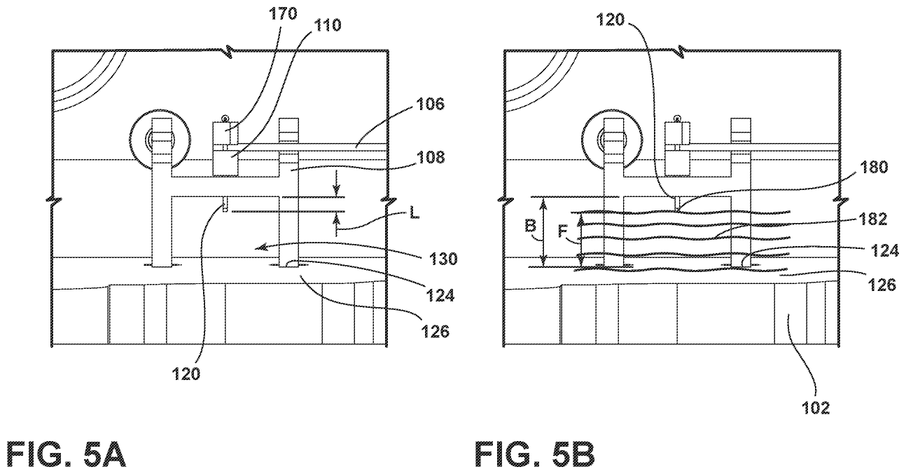

Referring to FIGS. 5A and 5B, the sensor assembly 100 is illustrated under a normal condition and in a condition in the presence of a conductive fluid, respectively. As illustrated in FIG. 5A, the electrical connector 110 is supported on the bracket 108 above the inner surface 126 of the housing 102. The cable 106 is connected to the electrical connector 110, retained or secured by the latch 170, and travels through the bracket 108. The pair of electrodes 120 extend a length L into the space 130 below the electrical connector 110. A lower extent 180 of the electrodes 120 is above the lower extent 124 of the bracket 108. Under normal conditions, the pair of electrodes 120 are separated from each other such that each electrode of the pair of electrodes 120 is conductively isolated from the other electrode. There is no change in conductivity and thus no signals are relayed to the circuit board 104 (see, e.g., FIG. 1) via the electrodes 120 and cable 106.

As illustrated in FIG. 5B, a conductive fluid 182 is in contact with the pair of electrodes 120. For example, conductive fluid 182 has entered the housing 102 and has filed to a depth such that the fluid 182 is touching the pair of electrodes 120. Under conditions when the conductive fluid 182 is in contact with the pair of electrodes 120, a low resistance path is formed through the conductive fluid 182 that conductively connects the pair of electrodes 120. When the pair of electrodes 120 are electrically connected (e.g., in the presence of the conductive fluid 182), an electrical signal is provided to the circuit board 104 from the electrical connector 110 via the cable 106. The electrical signal is due to the change in resistance from the formation of the low resistance path between the electrodes 120 and the change in conductivity. When the circuit board 104 detects the electrical signal from the change in resistance, the circuit board 104 effectuates reduction and/or termination of power distribution to a battery.

Referring to FIG. 5B, the bracket 108 is supported by the first leg 144 and the second leg 146 (see, e.g., FIG. 4) a bracket distance (or bracket height) B above the inner surface 126 of the housing 102. The bracket distance B may be increased or decreased in different applications with brackets 108 of different sizes. The length L of the electrodes (see, e.g., FIG. 5A) is the length from the crossbeam 148 to the lower extent 180 of the electrodes 120. The length L may be increased or decreased in different application with electrodes 120 of different sizes. A sensing threshold fluid depth F of the fluid 182 to create a low resistance path by contacting the electrodes 120 is the distance between the inner surface 126 of the housing 102 and the lower extent 180 of the electrodes 120. The fluid depth F to contact the electrodes 120 may increase or decrease when one or both of the electrode length L and the bracket distance B are increased or decreased. As generally illustrated, in embodiments the fluid 182 may wet the legs of a bracket 108 and inner surface 126 of the housing. The bracket 108 may be a non-sealed part and a fluid 182 may freely move around the bracket. A fluid depth (of fluid height) F may be equal the bracket distance B minus the length L of the electrodes. However, as generally noted, fluid depth F can be a design variable that can be selected or controlled by selection or control of B and L, as variables. In embodiments, the fluid depth F may be chosen so that false triggers, e.g., those associated with condensation, do not stop vehicle/system operation.

Referring to FIG. 7, in some configurations, a plurality of electrical connectors (e.g., a first connector 110A, a second connector 110B, and a third connector 110C) and a plurality of brackets (e.g., a first bracket 108A, a second bracket 108B, and a third bracket 108C) may be positioned along the cable 106 at different locations. For example, the first connector 110A and the first bracket 108A may be positioned at or about the first end 140 of the cable 106. The second connector 110B and the second bracket 108B may be positioned at or about a second location on the cable 106. The third connector 110C and the third bracket 108C may be positioned at or about a third location on the cable 106. A fourth connector 110D may be positioned at or about the second end 142 of the cable 106 (see, e.g., FIG. 1-3), electrically connecting the cable 106 to the circuit board 104. The length of the cable 106 and the number of electrical connectors 110 and brackets 108 may be dependent on the application of the sensor assembly 100. Each connector 110 may be positioned along the cable 106 at desired locations—e.g., where it may be worthwhile or important, or even crucial, to detect conductive fluid 182 prior to the fluid 182 contacting the circuit board 104 or other connected battery components. Each connector 110 may provide information to the circuit board 104 with where conductive fluid 182 has been detected such that the circuit board 104 may take appropriate action based on said detected location. Thus, each connector of the plurality of connectors is providing information about conductive fluid 182 in their respective localized area, but collectively provide a map of conductive fluid 182 detected throughout the housing 102 that allows the circuit board 104 to selectively shut down and/or reduce a system based on fluid 182 location. Connectors 110 may also be positioned in various locations and on various surfaces of the housing 102 (e.g., third connector 110C) in case of situations where the conductive fluid 182 would normally be present at a bottom surface of the housing 126 but the housing 102 is no longer right-side up, for example, in roll over scenarios, where a different side of the housing 102 is now positioned as a bottommost surface. With connectors 110 on different surfaces of the housing 102, detection of conductive fluid 182 may still occur regardless of which surface of the housing 102 is bottom facing. For example, four connectors 110 are illustrated in FIG. 7, but additional or fewer connectors 110 may be utilized.

Each electrode 120 may be connected to a respective conductor 122 with low resistance (see, e.g., FIG. 6). In some configurations, a system may have more than one electrical connector 110 configured as sensors. In configurations, all electrodes 120 from the plurality of electrical connectors 110 that are connected with a given conductor 122 may have low electrical resistance amongst each other in normal conditions. In contrast, electrodes 120 connected to different conductors 122 may have high electrical resistance amongst each other in normal conditions. Under conditions when the electrodes 120 at a given electrical connector 110 are in contact with conductive fluid 182, a low resistance path can be formed between the electrodes 120 connected to different conductors 122. The change of resistance between the electrodes 120 can be detected by the circuit board 104. Each electrical connector 110 may provide a different change in resistance such that the circuit board 104 may determine which electrical connector 110, or connectors, of a plurality of electrical connectors 110 is in contact with the conductive fluid 182.

Proper functioning of each electrical connector 110 may be verified upon start-up of the system (e.g., when the vehicle is started). Resistors 178 may be positioned across each pair of electrodes 120 at each electrical connector 110 to check the presence of resistance at each electrode 120. (see, e.g., FIG. 4). If a voltage drop is detected across the resistors at start-up, the electrical connector 110 is functioning properly. A lack of a voltage drop may indicate that there is a fault in the system such as an open circuit or malfunctioning wiring.

The disclosure includes, without limitation, the following embodiments:

1. A sensor assembly, comprising: an electrical connector; a cable connected to the electrical connector; and a bracket; wherein the electrical connector includes a pair of electrodes electrically connected to the cable; the electrical connector is supported by the bracket such that the electrical connector is positioned above a bottom portion of the bracket; and the pair of electrodes are separated from each other and extend down from the electrical connector a length into a space provided below the electrical connector.

2. The sensor assembly according to embodiment 1, wherein the electrical connector, the bracket, and at least a portion of the cable are disposed in a housing.

3. The sensor assembly according to any of the preceding embodiments, wherein the cable includes at least two conductor wires; and the pair of electrodes pass through the cable and operatively connect with the at least two conductor wires.

4. The sensor assembly according to any of the preceding embodiments, wherein the cable is a planar cable.

5. The sensor assembly according to any of the preceding embodiments, wherein the pair of electrodes are adapted to form an electrical connection in the event a conductive fluid contacts the pair of electrodes.

6. The sensor assembly according to any of the preceding embodiments, wherein the cable is operatively connected to a circuit board.

7. The sensor assembly according to any of the preceding embodiments, wherein, when the pair of electrodes are electrically connected, an electrical signal is provided to the circuit board.

8. The sensor assembly according to any of the preceding embodiments, wherein a detection of the electrical signal effectuates reduction and/or termination of power distribution to or from a battery.

9. The sensor assembly according to any of the preceding embodiments, comprising one or more additional electrical connectors; wherein the one or more additional electrical connectors are each electrically connected to the cable.

10. The sensor assembly according to any of the preceding embodiments, wherein the electrical connector includes a latch adapted to secure the cable to the electrical connector.

11. The sensor assembly according to any of the preceding embodiments, wherein the pair of electrodes include an exposed portion that is remote from the electrical connector.

12. The sensor assembly according to any of the preceding embodiments, wherein, when a conductive fluid is not in contact with the pair of electrodes, each electrode of the pair of electrodes is conductively isolated from the other electrode.

13. The sensor assembly according to any of the preceding embodiments, wherein, when a conductive fluid contacts the pair of electrodes, a low resistance path electrically connects the pair of electrodes.

14. The sensor assembly according to any of the preceding embodiments, wherein a lower extent of the pair of electrodes is provided at a bracket distance (or bracket height) above a lower extent of the bracket, and a fluid depth distance (or depth sense distance) extends from the lower extent of the pair of electrodes to an internal fluid level.

15. The sensor assembly according to any of the preceding embodiments, wherein an increase or decrease in one or both of the length of the pair of electrodes and the bracket distance (or bracket height) changes the fluid depth distance (or depth sense distance).

16. A system for sensing a conductive fluid, comprising: a housing including a sensor assembly; the sensor assembly including: a circuit board; an electrical connector having a pair of electrodes; and a cable electrically connecting the pair of electrodes to the circuit board; wherein the electrical connector is supported by a bracket; and when a conductive fluid contacts the pair of electrodes, a low resistance path is detected by the circuit board.

17. The system according to any of the preceding embodiments, wherein the cable includes at least two conductor wires, and the pair of electrodes are connected to the at least two conductor wires.

18. The system according to any of the preceding embodiments, wherein the bracket is attached to the housing such that the electrical connector is positioned above a surface of the housing.

19. The system according to any of the preceding embodiments, comprising a plurality of electrical connectors provided at different positions along the cable.

20. The system according to any of the preceding embodiments, wherein the plurality of electrical connectors can provide independent signals to the circuit board.

Depending on design objectives, several variations for configuration involving a flat cable-connector may be employed. For example and without limitation, in one configuration, one flat cable conductor may be employed per electrode. Such a configuration may provide, inter alia, a fairly specific leakage location. In another configuration, two flat cable conductors may be shared between a plurality, or even all, electrodes. Such a configuration may not discern as precise a leakage location, but may be less expensive. In yet another configuration, one flat cable conductor may serve as a common between a plurality, or even all, sensor connectors that are connected to one electrode in each sensor connector. A unique flat cable conductor may be attached to a unique electrode in the sensor connector. Such a configuration may be able to discern a leak age location, but a distance between sensing electrodes may vary at each sensing head. Of course, the foregoing are just non-limiting embodiments.

In examples, an ECU may include an electronic controller and/or include an electronic processor, such as a programmable microprocessor and/or microcontroller. In embodiments, an ECU may include, for example, an application specific integrated circuit (ASIC). An ECU may include a central processing unit (CPU), a memory (e.g., a non-transitory computer-readable storage medium), and/or an input/output (I/O) interface. An ECU may be configured to perform various functions, including those described in greater detail herein, with appropriate programming instructions and/or code embodied in software, hardware, and/or other medium. In embodiments, an ECU may include a plurality of controllers. In embodiments, an ECU may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A sensor assembly, comprising:
an electrical connector;
a cable connected to the electrical connector; and
a bracket;
wherein the electrical connector includes a pair of electrodes electrically connected to the cable;
the electrical connector is supported by the bracket such that the electrical connector is positioned above a bottom portion of the bracket; and
the pair of electrodes are separated from each other and extend down from the electrical connector a length into a space provided below the electrical connector.

2. The sensor assembly of claim 1, wherein the electrical connector, the bracket, and at least a portion of the cable are disposed in a housing.

3. The sensor assembly of claim 1, wherein the cable includes at least two conductor wires; and
the pair of electrodes pass through the cable and operatively connect with the at least two conductor wires.

4. The sensor assembly of claim 1, wherein the cable is a planar cable.

5. The sensor assembly of claim 1, wherein the pair of electrodes are adapted to form an electrical connection in the event a conductive fluid contacts the pair of electrodes.

6. The sensor assembly of claim 1, wherein the cable is operatively connected to a circuit board.

7. The sensor assembly of claim 6, wherein, when the pair of electrodes are electrically connected, an electrical signal is provided to the circuit board.

8. The sensor assembly of claim 7, wherein a detection of the electrical signal effectuates reduction and/or termination of power distribution to or from a battery.

9. The sensor assembly of claim 1, comprising one or more additional electrical connectors;
wherein the one or more additional electrical connectors are each electrically connected to the cable.

10. The sensor assembly of claim 1, wherein the electrical connector includes a latch adapted to secure the cable to the electrical connector.

11. The sensor assembly of claim 1, wherein the pair of electrodes include an exposed portion that is remote from the electrical connector.

12. The sensor assembly of claim 1, wherein, when a conductive fluid is not in contact with the pair of electrodes, each electrode of the pair of electrodes is conductively isolated from the other electrode.

13. The sensor assembly of claim 1, wherein, when a conductive fluid contacts the pair of electrodes, a low resistance path electrically connects the pair of electrodes.

14. The sensor assembly of claim 1, wherein a lower extent of the pair of electrodes is provided at a bracket distance above a lower extent of the bracket, and a fluid depth distance extends from the lower extent of the pair of electrodes to an internal fluid level.

15. The sensor assembly of claim 14, wherein an increase or decrease in one or both of the length of the pair of electrodes and the bracket distance changes the fluid depth distance.

16. A system for sensing a conductive fluid, comprising:
a housing including a sensor assembly;
the sensor assembly including:
a circuit board;
an electrical connector having a pair of electrodes; and
a cable electrically connecting the pair of electrodes to the circuit board;
wherein the electrical connector is supported by a bracket; and
when a conductive fluid contacts the pair of electrodes, a low resistance path is detected by the circuit board.

17. The system of claim 16, wherein the cable includes at least two conductor wires, and the pair of electrodes are connected to the at least two conductor wires.

18. The system of claim 16, wherein the bracket is attached to the housing such that the electrical connector is positioned above a surface of the housing.

19. The system of claim 16, comprising a plurality of electrical connectors provided at different positions along the cable.

20. The system of claim 19, wherein the plurality of electrical connectors can provide independent signals to the circuit board.
